(19) United States
(12) Patent Application Publication
(10) Pub. No.: US 2023/0142505 A1
(43) Pub. Date: May 11, 2023

(54) REPAIR METHOD FOR CHASSIS RAILS OF VEHICLES

(71) Applicant: GM Global Technology Operations LLC, Detroit, MI (US)

(72) Inventors: Liviu Ungureanu, North York (CA); Aaron D. Syts, Davisburg, MI (US); Shailesh I. Patel, Oakland, MI (US); Steven Joseph Schwartz, Oakland, MI (US); Eric A. Kirschke, Milford, MI (US)

(21) Appl. No.: 17/524,053

(22) Filed: Nov. 11, 2021

(51) Int. Cl. B62D 65/02; B62D 27/02; B62D 21/00

(52) U.S. Cl. CPC B62D 65/024; B62D 27/02; B62D 21/00

(57) ABSTRACT

In one exemplary embodiment, a method of repairing a chassis rail for a vehicle includes that a marking is identified on the chassis rail. The marking indicating where to cut the chassis rail. The method also includes that the chassis rail is cut proximate the marking to form a cut chassis rail portion. The method further includes a replacement rail assembly is slid onto the cut chassis rail portion. The replacement rail assembly including a replacement rail, an inner brace portion secured within the replacement rail, and a bracket wrapped at least partially around the replacement rail and secured to the replacement rail. The bracket including one or more fastener through-passages. The method further includes the replacement rail assembly is secured to the cut chassis rail portion.

### INTRODUCTION

The subject disclosure relates to chassis rails of vehicles, and more particularly relates to a method of repairing chassis rails.

Current production vehicles, such as an automobile, are originally equipped with impact protection components for absorbing a kinetic energy pulse generated from an impact event between the vehicle and an external object. The most prevalent type of impact protection component is the front and rear vehicle bumper structure. A vehicle bumper is normally composed of a high-strength yet deformable crossbeam that is rigidly secured to the body in white (BIW) chassis and covered by an A-surface cladding (more commonly known as a “bumper fascia”). Chassis rails of the BIW chassis and the bumper crossbeams are typically designed to deform in a controlled and predictable manner to optimize impact energy absorption, while the bumper fascia is merely provided as an aesthetically appealing shell for concealing the crossbeam.

### SUMMARY

In one exemplary embodiment, a method of repairing a chassis rail for a vehicle is provided. The method includes that a marking is identified on the chassis rail. The marking indicating where to cut the chassis rail. The method also includes that the chassis rail is cut proximate the marking to form a cut chassis rail portion. The method further includes a replacement rail assembly is slid onto the cut chassis rail portion. The replacement rail assembly including a replacement rail, an inner brace portion secured within the replacement rail, and a bracket wrapped at least partially around the replacement rail and secured to the replacement rail. The bracket including one or more fastener through-passages. The method further includes the replacement rail assembly is secured to the cut chassis rail portion.

In addition to one or more of the features described herein, or as an alternative, further embodiments may include that that the replacement rail assembly is secured to the cut chassis rail portion by securing the replacement rail assembly to the cut chassis rail portion using one or more fastening mechanisms.

In addition to one or more of the features described herein, or as an alternative, further embodiments may include that the replacement rail assembly is secured to the cut chassis rail portion by bolting the replacement rail assembly to the cut chassis rail portion.

In addition to one or more of the features described herein, or as an alternative, further embodiments may include that the inner brace portion includes one or more through-passages.

In addition to one or more of the features described herein, or as an alternative, further embodiments may include that the replacement rail assembly is secured to the cut chassis rail portion by marking a location of each of the one or more fastener through-passages of the bracket on the cut chassis rail portion, drilling one or more through holes in the cut chassis rail portion where the location of each of the one or more fastener through-passages was marked on the cut chassis rail portion, aligning the one or more through holes with the one or more fastener through-passages and the one or more through-passages, inserting a fastening mechanism into the aligned fastener through-passages, through holes, and through-passages, and securing the replacement rail assembly to the cut chassis rail portion with the fastening mechanism.

In addition to one or more of the features described herein, or as an alternative, further embodiments may include that the bracket is welded to the cut chassis rail portion.

In addition to one or more of the features described herein, or as an alternative, further embodiments may include that the bracket is welded to the replacement rail.

In addition to one or more of the features described herein, or as an alternative, further embodiments may include that the inner brace portion is welded to the replacement rail.

In addition to one or more of the features described herein, or as an alternative, further embodiments may include that after marking the location of each of the one or more fastener through-passages on the replacement rail and before drilling the one or more through holes in the cut chassis rail portion where the location of each of the one or more fastener through-passages was marked, the method further includes sliding the replacement rail off the cut chassis rail portion in order to drill the one or more through holes where the location of each of the one or more fastener through-passages was marked.

In addition to one or more of the features described herein, or as an alternative, further embodiments may include that after drilling the one or more through holes in the cut chassis rail portion and before aligning the one or more fastener through-passages and the one or more through-passages, the method further includes sliding the replacement rail back onto the cut chassis rail portion.

In addition to one or more of the features described herein, or as an alternative, further embodiments may include that after drilling the one or more through holes in the cut chassis rail portion and before aligning the one or more fastener through-passages and the one or more through-passages, the method further includes applying an anticorrosive weldable primer onto the cut chassis rail portion.

In addition to one or more of the features described herein, or as an alternative, further embodiments may include that after drilling the one or more through holes in the cut chassis rail portion was marked on the cut chassis rail portion and before aligning the one or more fastener through-passages and the one or more through-passages, the method further includes applying an anticorrosive weldable primer onto the cut chassis rail portion and sliding the replacement rail back onto the cut chassis rail portion.

In addition to one or more of the features described herein, or as an alternative, further embodiments may include that the chassis rail is a front chassis rail of the vehicle.

In one exemplary embodiment, a cut chassis rail portion. The repaired chassis rail also includes a replacement rail assembly secured to the cut chassis rail portion.

In addition to one or more of the features described herein, or as an alternative, further embodiments may include that the replacement rail assembly is secured to the cut chassis rail portion via one or more fastening mechanisms.

In addition to one or more of the features described herein, or as an alternative, further embodiments may include that the replacement rail assembly is secured to the cut chassis rail portion via one or more welds.

In addition to one or more of the features described herein, or as an alternative, further embodiments may include that the replacement rail assembly is secured to the cut chassis rail portion via one or more bolts.

In addition to one or more of the features described herein, or as an alternative, further embodiments may include that the replacement rail assembly is secured to the cut chassis rail portion via one or more rivets.

In addition to one or more of the features described herein, or as an alternative, further embodiments may include that the replacement rail assembly further includes a replacement rail, a bracket wrapped at least partially around the replacement rail, and an inner brace portion secured within the replacement rail.

In addition to one or more of the features described herein, or as an alternative, further embodiments may include one or more fastening mechanisms. The replacement rail, the bracket, the inner brace portion, and the cut chassis rail portion are secured together via the one or more fastening mechanisms.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a front perspective view of a vehicle that includes a left front chassis rail and a right front chassis rail;

FIG. 2 is a perspective view of a left front chassis rail with a marking and a right front chassis rail with a marking, according to an embodiment of the present disclosure;

FIG. 3 is a perspective view of an aft section of the left front chassis rail and a replacement rail, according to an embodiment of the present disclosure;

FIG. 4 is an axial view of the replacement rail assembly, according to an embodiment of the present disclosure; and

FIGS. 5A, 5B, 5C, and 5D are a flow diagram illustrating a method of repairing the front chassis rail of a vehicle, according to an embodiment of the present disclosure.

### DETAILED DESCRIPTION

The following description is merely exemplary in nature and is not intended to limit the present disclosure, its application or uses. It should be understood that throughout the drawings, corresponding reference numerals indicate like or corresponding parts and features.

A chassis of a vehicle is often difficult to repair after a collision. The embodiments disclosed herein seek to provide a method for repairing a front chassis rail by removing a damaged forward portion of the front chassis rail and replacing the damaged forward portion with a replacement rail that is secured to an aft section of the front chassis rail that was not damaged.

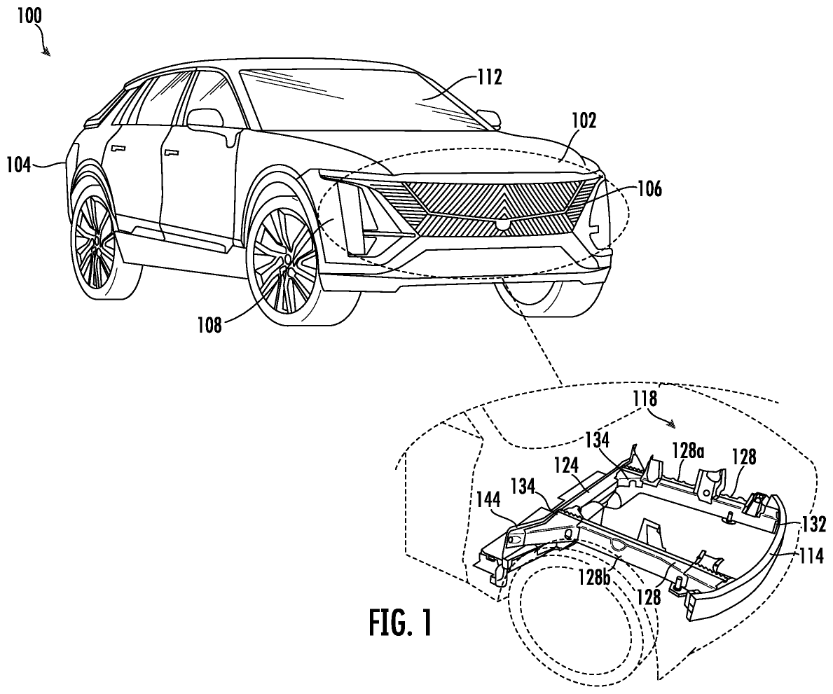

Referring now to FIG. 1, a front perspective view of a vehicle 100 is illustrated and portrayed herein for purposes of discussion as a sports utility vehicle (SUV). The vehicle 100 is merely an exemplary application with which the novel aspects and features of this disclosure may be practiced. As such, it is understood that the embodiments disclosed herein are not limited to SUVs and the embodiments disclosed here may be applicable to other vehicles.

The vehicle 100 includes a front end 102 and a rear end 104 located opposite the front end 102. The vehicle 100 also includes a passenger compai tinent 112.

For purposes of this Detailed Description, relative clauses and spatial adjectives, such as “front,” “rear,” “vertical” and “horizontal,” are with respect to the vehicle 100 and forward and reverse driving directions of the vehicle 100. In the abridged perspective view of the chassis 118 inset into FIG. 1 there is shown a pair of longitudinally oriented front chassis rails 128 interconnected by a U-shaped box- girder crossmember 124. The pair of front chassis rails 128 are located at a front of the chassis 118 proximate the front end 102 of the vehicle 100. The front chassis rails 128 define a load travel path during a frontal impact event. Other under body structures and related features are deemed to be within the scope of this disclosure. The front chassis rails 128 are configured to connect to a bumper 114 at a forward end 132 of the front chassis rails 128 proximate the front end 102 of the vehicle 100. The front chassis rails 128 are configured to connect to a main portion 144 of the chassis at a rearward end 134.

The front chassis rails 128 may include a left front chassis rail 128a located on a left side 106 of the vehicle 100 and a right front chassis rail 128b located on a right side 108 of the vehicle 100. The embodiments described herein are applicable to both the left front chassis rails 128a and the right front chassis rail 128b. It is understood that while front chassis rails 128 are described herein, the embodiments disclosed herein are also applicable to rear chassis rails or any other chassis rail of the vehicle 100.

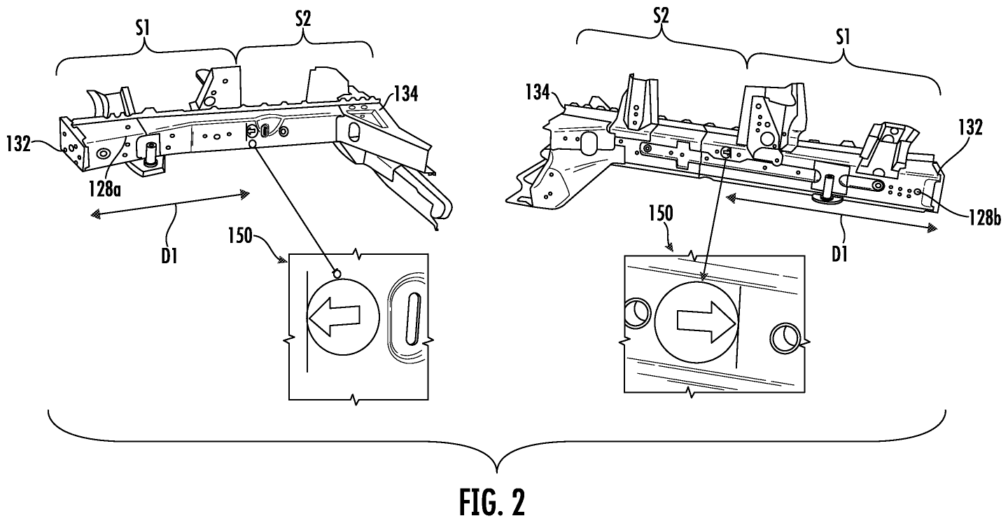

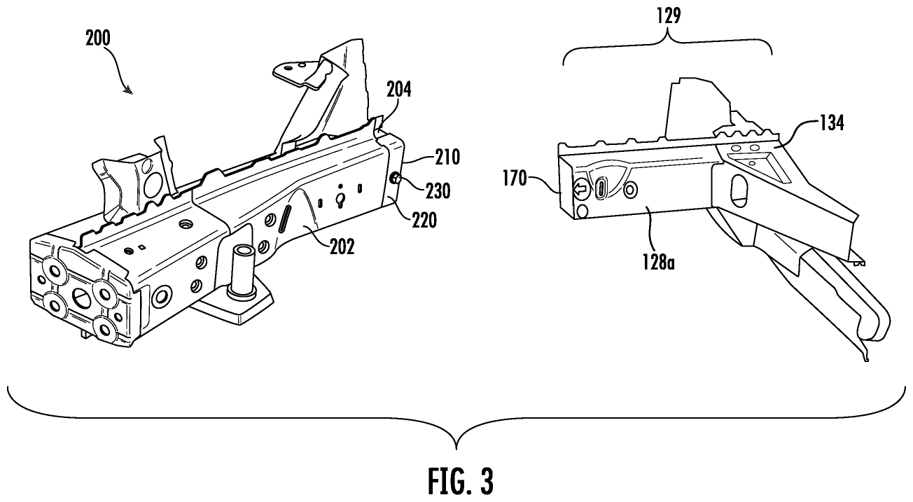

Referring now to FIG. 2, with continued reference to FIG. 1, a perspective view of the left front chassis rail 128a and the right front chassis rail 128b is illustrated in accordance with an embodiment of the present disclosure. During a frontal impact, the chassis rails 128 may be configured to deform inwardly from the forward end 132 up to a selected distance D1 at certain vehicle speeds to absorb energy from the collision. In order words, a forward section S1 of the chassis rail 128 located proximate the forward end 132 is configured to compress (up to a selected vehicle speed) while an aft section S2 of the chassis rails 128 proximate the rearward end 134 is configured to not compress or remain rigid (up to the selected vehicle speed). The aft section S2 may also be referred to as a cut chassis rail portion 129 (See FIG. 3) after the forward section S1 has been removed. Above the selected vehicle speed both the forward section S1 and the aft section S2 of the chassis rails 128 may compress.

Since the aft section S2 of a chassis rail 128 is configured to not compress at vehicles speeds below the selected vehicle speed then the aft section S2 may remain undamaged while the forward section S1 of the chassis rail 128 may be removed and replaced in accordance with a method describe further herein.

As illustrated in FIG. 2, each of the left front chassis rail 128a and the right front chassis rail 128b may include a marking 150 indicating where each front chassis rail 128 may be cut after a crash using the repair method further described herein. The marking 150 may be located at the first distance D1 from the forward end 132 of the front chassis rail 128. The marking 150 indicates that the front chassis rail 128 may be cut at or forward of the marking 150. As illustrated in FIG. 2, the marking 150 may include an arrow pointing toward the forward end 132 of the front chassis rail 128 and a cut line located forward of the arrow.

The marking 150 may be an emblem, logo, symbol, text, pictograph, pictograph, ideogram, or any similar marking. The marking 150 may be attached to the front chassis rail 128 (e.g., sticker or decal on the front chassis rail 128), etched into the front chassis rail 128, printed onto the front chassis rail 128, embedded into the front chassis rail 128, embossed into the front chassis rail 128, stamped into the front chassis rail 128, or applied to the front chassis rail 128 using any other method known to one of skill in the art.

Referring now to FIG. 3, with continued reference to FIGS. 1 and 2, a perspective view of the left front chassis rail 128a after the forward section S1 has been removed or cut off is illustrated, according to an embodiment of the present disclosure. It is understood that while FIG. 3 and the associated description discuss the left front chassis rail 128a, the embodiments discussed are equally applicable to the right front chassis rail 128b.

A perspective view of a replacement rail assembly 200 is also illustrated in FIG. 3, according to an embodiment of the present disclosure. The replacement rail assembly 200 is configured to slide onto the cut end 170 of the cut chassis rail portion 129 of the left front chassis rail 128a and then be securely attached thereto. The replacement rail assembly 200 includes a front replacement rail 202 that is configured to be a functional replica of the forward section S1 of the left front chassis rail 128a.

The replacement rail assembly 200 includes an inner brace portion 204 and a bracket 220. The inner brace portion 204 is located within the front replacement rail 202 and the bracket 220 is wrapped at least partially around the front replacement rail 202. The inner brace portion 204 is configured to slide into or within the cut end 170 of the cut chassis rail portion 129 and the bracket 220 is configured to slide over the cut end 170 of the cut chassis rail portion 129 when the replacement rail assembly 200 is installed. The front replacement rail 202 is configured to abut the cut end 170 of the cut chassis rail portion 129 when the replacement rail assembly 200 is installed.

The replacement rail assembly 200 may be secured to the left front chassis rail 128a via the bracket 220, one or more fastening mechanisms 230, a weld between the bracket 220 and the replacement rail assembly 200, and a weld between the bracket 220 and the left front chassis rail 128a, as discussed further herein.

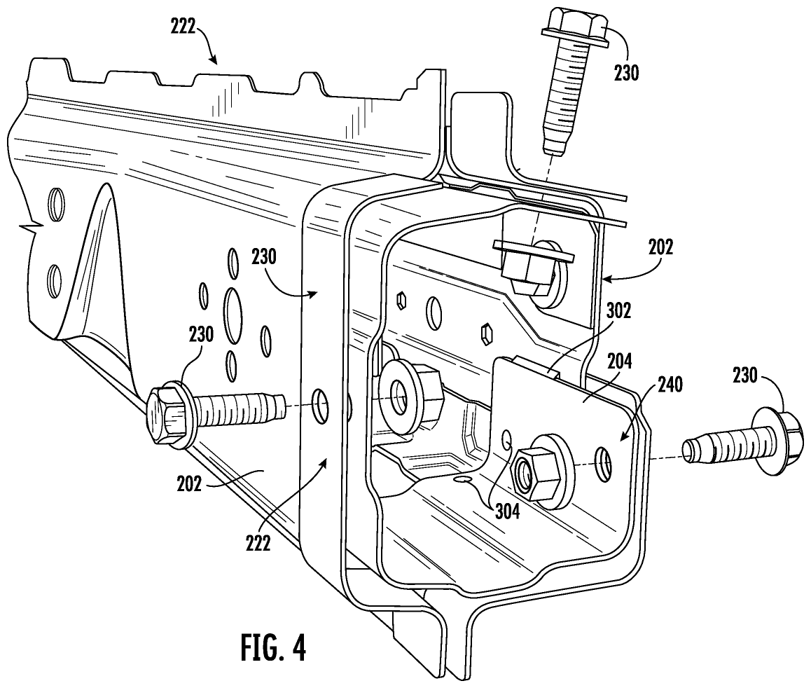

Referring now to FIG. 4, with continued reference to FIGS. 1-3, an axial view of the replacement rail assembly 200 is illustrated, according to an embodiment of the present disclosure. It is understood that while FIG. 4 and the associated description discuss the left front chassis rail 128a, the embodiments discussed are equally applicable to the right front chassis rail 128b.

As illustrated in FIG. 4, the replacement rail assembly 200 may be secured to the left front chassis rail 128a using the bracket 220 and one or more fastening mechanisms 230. The bracket 220 is secured to the front replacement rail 202 by one or more metal inert gas welds (MIG) welds (not visible in FIG. 4). It is understood that while MIG welds are described herein to secure the bracket 220 to the front replacement rail 202, any type of weld known to one of skill in the art may be utilized. The inner brace portion 204 is secured to the front replacement rail 202 by one or more metal inert gas welds (MIG) welds 302 and one or more puddle welds 304. It is understood that while MIG welds 302 and puddle welds 304 are described herein to secure the inner brace portion 204 to the front replacement rail 202, any type of weld known to one of skill in the art may be utilized.

The bracket 220 wraps at least partially around an outer perimeter of the front replacement rail 202 and the left front chassis rail 128a proximate the cut end 170 after the cut end is inserted into the replacement rail assembly 200. The bracket 220 is secured to the left front chassis rail 128a by one or more metal inert gas welds (MIG) welds (not shown). It is understood that while MIG welds (Not shown) are described herein to secure the bracket 220 to the front replacement rail 202, any type of weld known to one of skill in the art may be utilized.

Three fastening mechanisms 230 may be utilized to secure the replacement rail assembly 200 to the left front chassis rail 128a. The fastening mechanism 230 may be a bolt and nut, a blind rivet, or similar fastening mechanism.

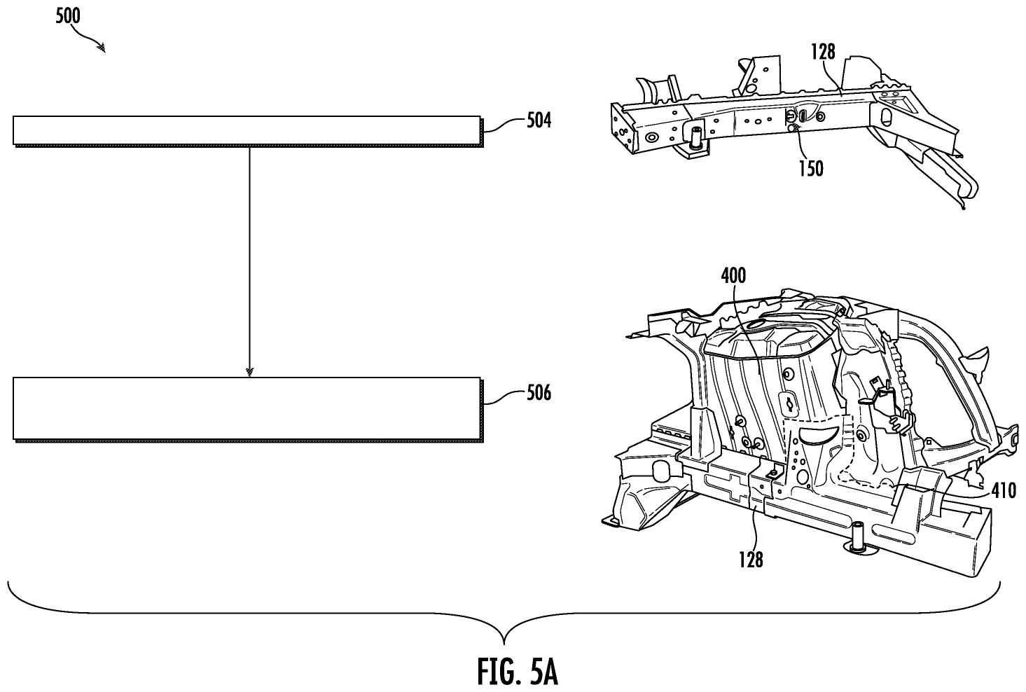

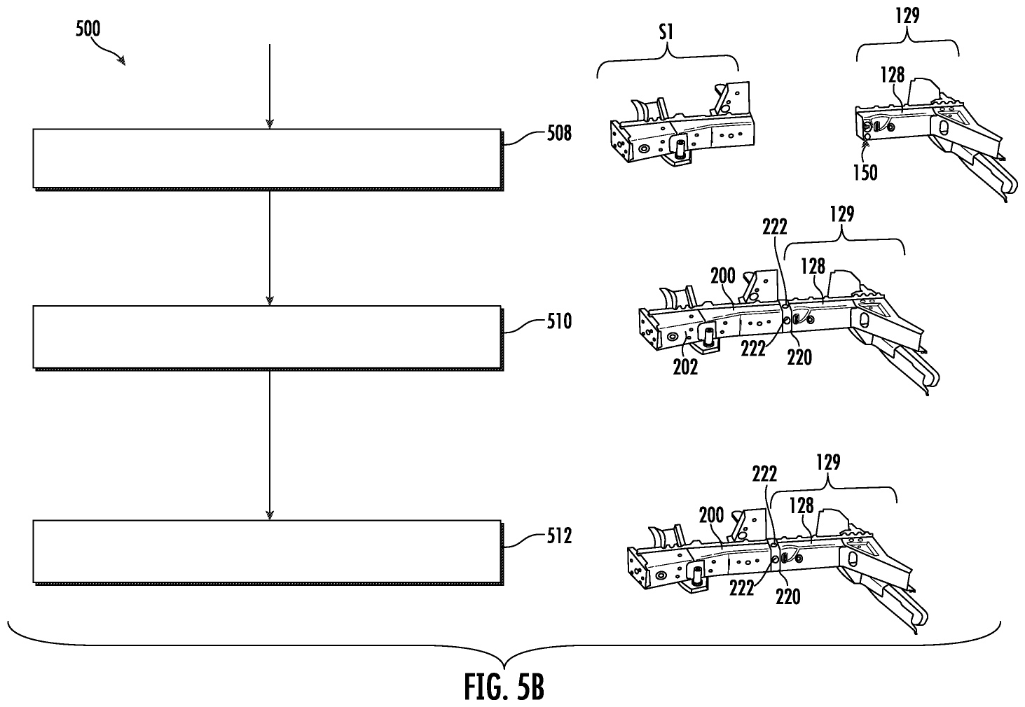

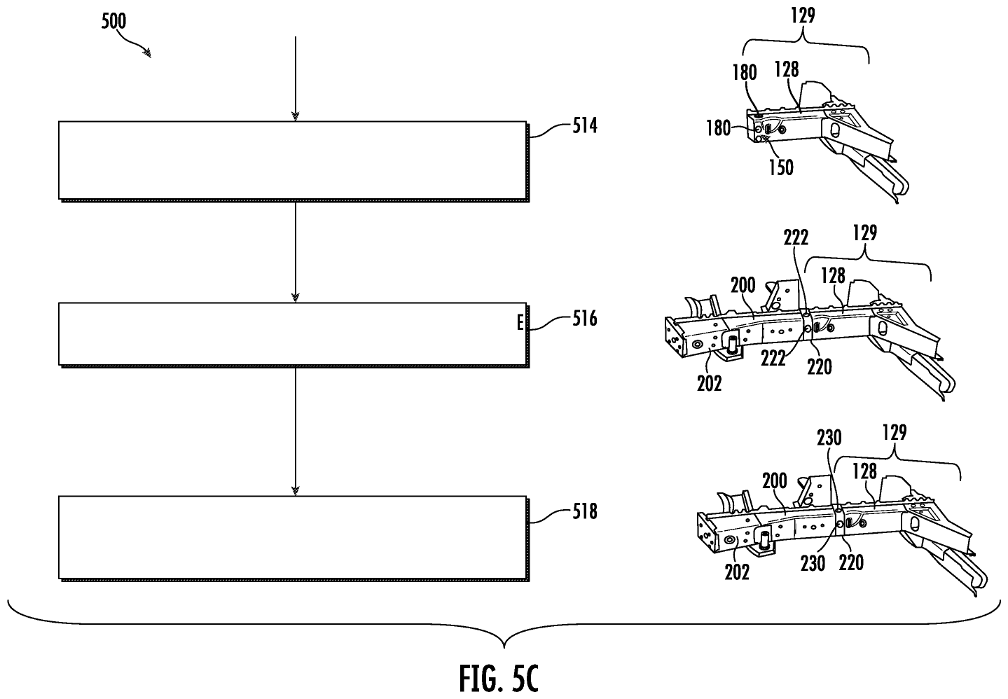

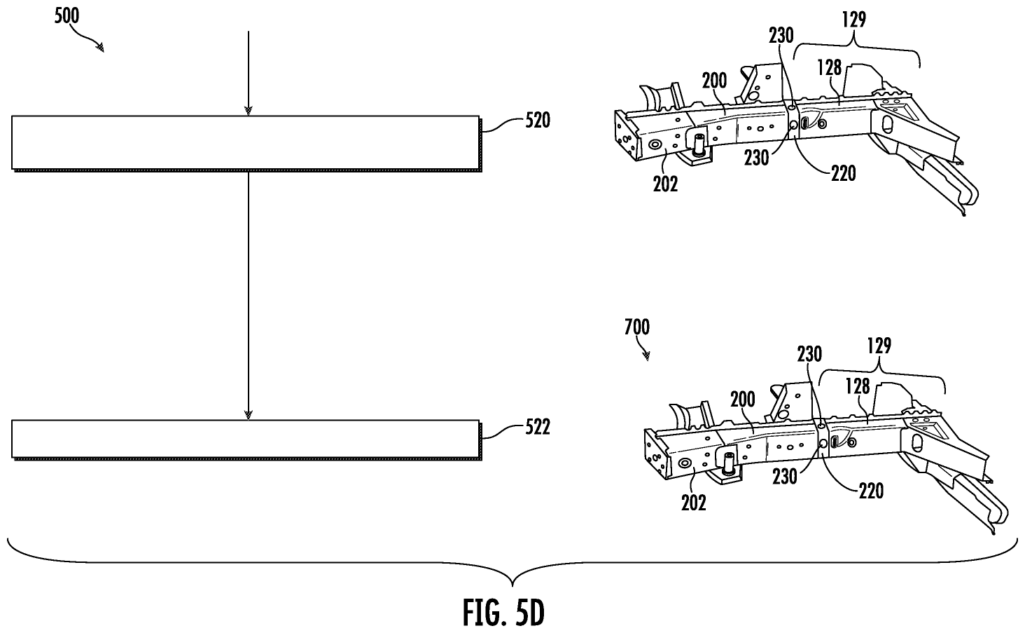

The inner brace portion 204 of the replacement rail assembly 200 comprises one or more through-passages 240. The bracket 220 includes one or more fastener through-passages 222 that are configured to align with the one or more through-passages 240. The fastener through-passages 222 are used as a template to drill through holes 180 (see FIG. 5C) in the front chassis rail 128, as discussed in Method 500. The fastener through-passage 222, the through hole 180 (see FIG. 5C), and the through-passage 240 are all configured to align with each other to allow the fastening mechanism 230 to be inserted through and secure the replacement rail assembly 200 to the front chassis rail 128.

Referring to FIGS. 5A, 5B, 5C, and 5D, with continued reference to FIGS. 1-4, a method 500 of repairing a front chassis rail 128 for a vehicle 100 is illustrated, in accordance with an embodiment of the present disclosure. The method 500 may be applicable to the left front chassis rail 128a or the right front chassis rail 128b of the vehicle 100. It is understood that while the method 500 is described using the front chassis rail 128, the method is also applicable to any chassis rail of the vehicle 100 including but not limited to a rear chassis rail.

At block 504, a marking 150 is identified on the front chassis rail 128. The marking 150 indicating where to cut the front chassis rail 128. At block 506, spot welds 410 that join the front chassis rail 128 to a wheelhouse 400 of the vehicle 100 are removed or any other vehicle chassis member.

Block 506 may be optional if the front chassis rail 128 is not joined to the wheelhouse 400. Block 506 may occur prior to block 504.

At block 508, the front chassis rail 128 is cut proximate the marking 150 to form a cut chassis rail portion 129. This separates the front chassis rail 128 into the first section S1 and the cut chassis rail portion 129. The front chassis rail 128 may be cut forward of the marking 150 or at the marking 150.

At block 510, a replacement rail assembly 200 is slid onto the cut chassis rail portion 129. The replacement rail assembly 200 of method 500 includes at least the front replacement rail 202, the inner brace portion 204, and the bracket 220. The inner brace portion 204 may be welded within and onto the front replacement rail 202 prior to method 500 to form the replacement rail assembly 200. The bracket 220 may also be welded onto the front replacement rail 202 prior to method 500.

The inner brace portion 204 of the replacement rail assembly 200 comprises one or more through-passages 240 (see FIG. 4). The bracket 220 includes one or more fastener through-passages 222 that are configured to align with the one or more through-passages 240.

Following block 510, the replacement rail assembly 200 may be secured to the front chassis rail 128. The replacement rail assembly 200 may be secured to cut chassis rail portion 129 via one or more different methods and/or using one or more fastening mechanisms 230. The replacement rail assembly 200 may be secured to cut chassis rail portion 129 by bolting the replacement rail assembly 200 to the cut chassis rail portion 129. The replacement rail assembly 200 may be secured to cut chassis rail portion 129 by welding the replacement rail assembly 200 to the cut chassis rail portion 129. The replacement rail assembly 200 may be secured to cut chassis rail portion 129 by riveting the replacement rail assembly 200 to the cut chassis rail portion 129.

The replacement rail assembly 200 may be secured to cut chassis rail portion 129 via blocks 512-520.

At block 512, a location of each of the one or more fastener through-passages 222 is marked on cut chassis rail portion 129. Block 512 occurs while the front replacement rail 202 is on the cut chassis rail portion 129. The one or more fastener through-passages 222 may be used as stencils to sketch/mark the correct location of the one or more fastener through-passages 222 on the cut chassis rail portion 129, so that they will later align will through holes 180 drilled later in block 514.

At block 514, one or more through holes 180 are drilled in the cut chassis rail portion 129 to align with the one or more fastener through-passages 222 and the one or more through-passages 240. The one or more through holes 180 are drilled in the cut chassis rail portion 129 where the location of each of the one or more fastener through-passages 222 was marked on the cut chassis rail portion 129. The replacement rail assembly 200 may be removed from the cut chassis rail portion 129 prior to the drilling at block 514 in order to drill the one or more through holes 180 therein. Alternatively, the drilling in block 514 may occur when the replacement rail assembly 200 is located on the cut chassis rail portion 129. If the replacement rail assembly 200 was removed from the cut chassis rail portion 129 prior to the drilling at block 514 then post block 514 the replacement rail assembly 200 may be slid back onto the cut chassis rail portion 129. An anticorrosive weldable primer may be applied onto the cut chassis rail portion 129 following the drilling in block 514.

At block 516, the one or more through holes 180 are aligned with the one or more through-passages 240 and the one or more fastener through-passages 222 by sliding the replacement rail assembly 200 into engagement with the cut chassis rail portion 129.

At block 518, a fastening mechanism 230 is inserted into each of the aligned fastener through-passages 222, through holes 180, and through-passages 240.

At block 520, the replacement rail assembly 200 is secured to the cut chassis rail portion 129 with the fastening mechanisms 230.

At block 522, the bracket 220 may be welded to the cut chassis rail portion 129. This forms a repaired front chassis rail 700, as illustrated in FIG. 5D.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A method of repairing a chassis rail for a vehicle, the method comprising:
identifying a marking on the chassis rail, the marking indicating where to cut the chassis rail;
cutting the chassis rail proximate the marking to form a cut chassis rail portion;
sliding a replacement rail assembly onto the cut chassis rail portion, the replacement rail assembly comprising a replacement rail, an inner brace portion secured within the replacement rail, and a bracket wrapped at least partially around the replacement rail and secured to the replacement rail, the bracket comprising one or more fastener through-passages; and
securing the replacement rail assembly to the cut chassis rail portion.

2. The method of claim 1, wherein securing the replacement rail assembly to the cut chassis rail portion further comprises:
securing the replacement rail assembly to the cut chassis rail portion using one or more fastening mechanisms.

3. The method of claim 1, wherein securing the replacement rail assembly to the cut chassis rail portion further comprises:
bolting the replacement rail assembly to the cut chassis rail portion.

4. The method of claim 1, wherein the inner brace portion comprises one or more through-passages.

5. The method of claim 4, wherein securing the replacement rail assembly to the cut chassis rail portion further comprises:
marking a location of each of the one or more fastener through-passages of the bracket on the cut chassis rail portion;
drilling one or more through holes in the cut chassis rail portion where the location of each of the one or more fastener through-passages was marked on the cut chassis rail portion;
aligning the one or more through holes with the one or more fastener through- passages and the one or more through-passages;
inserting a fastening mechanism into the aligned fastener through-passages, through holes, and through-passages; and
securing the replacement rail assembly to the cut chassis rail portion with the fastening mechanism.

6. The method of claim 5, further comprising
welding the bracket to the cut chassis rail portion.

7. The method of claim 1, further comprising
welding the bracket to the replacement rail.

8. The method of claim 1, further comprising
welding the inner brace portion to the replacement rail.

9. The method of claim 5, wherein after marking the location of each of the one or more fastener through-passages on the replacement rail and before drilling the one or more through holes in the cut chassis rail portion where the location of each of the one or more fastener through-passages was marked, the method further comprises:
sliding the replacement rail off the cut chassis rail portion in order to drill the one or more through holes where the location of each of the one or more fastener through-passages was marked.

10. The method of claim 9, wherein after drilling the one or more through holes in the cut chassis rail portion and before aligning the one or more fastener through-passages and the one or more through-passages, the method further comprises:
sliding the replacement rail back onto the cut chassis rail portion.

11. The method of claim 9, wherein after drilling the one or more through holes in the cut chassis rail portion and before aligning the one or more fastener through-passages and the one or more through-passages, the method further comprises:
applying an anticorrosive weldable primer onto the cut chassis rail portion.

12. The method of claim 9, wherein after drilling the one or more through holes in the cut chassis rail portion and before aligning the one or more fastener through-passages and the one or more through-passages, the method further comprises:
applying an anticorrosive weldable primer onto the cut chassis rail portion; and
sliding the replacement rail back onto the cut chassis rail portion.

13. The method of claim 1, wherein the chassis rail is a front chassis rail of the vehicle.

14. A repaired chassis rail for a vehicle, the repaired chassis rail comprising:
a cut chassis rail portion; and
a replacement rail assembly secured to the cut chassis rail portion.

15. The repaired chassis rail of claim 14, wherein the replacement rail assembly is secured to the chassis rail via one or more fastening mechanisms.

16. The repaired chassis rail of claim 14, wherein the replacement rail assembly is secured to the cut chassis rail portion via one or more welds.

17. The repaired chassis rail of claim 14, wherein the replacement rail assembly is secured to the cut chassis rail portion via one or more bolts.

18. The repaired chassis rail of claim 14, wherein the replacement rail assembly is secured to the cut chassis rail portion via one or more rivets.

19. The repaired chassis rail of claim 14, wherein the replacement rail assembly further comprises:
a replacement rail;
a bracket wrapped at least partially around the replacement rail; and
an inner brace portion secured within the replacement rail.

20. The repaired chassis rail of claim 19, further comprising:
one or more fastening mechanisms, wherein the replacement rail, the bracket, the inner brace portion, and the cut chassis rail portion are secured together via the one or more fastening mechanisms.
